(19) United States
(12) Patent Application Publication
(10) Pub. No.: US 2010/0296877 A1
(43) Pub. Date: Nov. 25, 2010

(54) PRODUCT INCLUDING CELLS FORMED BY BAND STAPLING AND METHOD AND DEVICE FOR PRODUCING A CELLULAR PRODUCT

(75) Inventor: Yves Durkheim, Chartres (FR)

Correspondence Address: LOWE HAUPTMAN HAM & BERNER, LLP, 1700 DIAGONAL ROAD, SUITE 300, ALEXANDRIA, VA, 22314, US

(73) Assignee: AFITEX INTERNATIONAL

(21) Appl. No.: 12/810,527

(22) PCT Filed: Dec. 10, 2008
(86) PCT No.: PCT/FR08/01717

§ 371 Date: Aug. 12, 2010

(30) Foreign Application Priority Data
Dec. 26, 2007 (FR) 07 09108

(51) Int. Cl. E02D 17/20; B32B 3/12; B23P 11/00; B25C 5/06

(52) U.S. Cl. 405/302.6; 428/116; 29/525.01; 227/19

(57) ABSTRACT

The cellular structure product in honeycomb form is made by assembling superposed bands of the same width. Two adjacent bands are attached to one another by a plurality of first series and second series of staples. Each of the cells of the product breaks down into two opposite portions belonging to two adjacent bands, these two portions being connected together at the edges of the cell by a first series and a second series of staples aligned according to the band width. The alignment of staples of each of the series can be done across the band width by a stapler fitted with an anvil holder offset laterally, after positioning of the anvil of the stapler under two adjacent bands.

In the non-deployed product, each band is thus stapled alternately twice with a lower band and twice with an upper band.

### RELATED APPLICATIONS

The present application is based on, and claims priority from, FR Application Number 0709108, filed Dec. 26, 2007, and PCT Application Number PCT/FR08/001717, filed Dec. 10, 2008, the disclosures of which are hereby incorporated by reference herein in their entireties.

### TECHNICAL FIELD

One or more embodiments of the present invention relate to cellular structures in the field of supporting. One or more embodiments of the invention relate more particularly to a cellular product of good shelf life over time, a method and manufacturing equipment of such a product.

### BACKGROUND

Protective coverings of soils against erosion, having cellular structures, are known especially from document WO 95/35417. Woven or non-woven textile bands are assembled by adhesion or by sewing at contact surfaces to form the cell walls, in honeycomb form. In a network of cells formed by several bands (N−1, N, N+1) placed in parallel, it is understood that a band N can be broken down into a succession of patterns composed of a portion (41) stuck to an adjacent band N−1, a non-stuck intermediate portion (42), a portion (43) stuck to the other adjacent band N+1 and an intermediate portion (44) joining the following pattern. FIG. 4 illustrates this arrangement for making hexagonal cells. The bands forming the network of cells are attached to a plane support structure (40) by stapling. This type of fixing requires the formation of tabs at the edges in contact with the plane structure, effectively complicating making of the cellular product.

Also in this type of product, the rigidity of the structure is obtained by means of a coating method of the fibres of the bands in resin. But it has been noted that rigidity diminished over time with this type of impregnation.

### SUMMARY

An aim of one or more embodiments of the present invention therefore is to eliminate one or more of the disadvantages of the prior art by proposing a cellular product remaining relatively simple in design and which has good shelf life over time, which can be used reliably for applications of shelf life of matter (for example: shelf life of terrain, casing for concrete to be cast on a slope).

This aim is attained by a cellular product, comprising a plurality of interconnected bands to form in a deployed form a cellular structure in honeycomb form, the product having a height which corresponds to the width of the bands for said deployed form, characterised in that the bands are connected to one another by staples, each of the cells of the product being formed by two portions belonging to two adjacent bands, these two portions being connected together by a first series and a second series of staples aligned according to the band width, these two series corresponding to two edges of the cell.

Therefore, the product according to one or more embodiments of the invention advantageously allows to do without adhesion resin, while producing a structure of satisfactory rigidity and resistance in the deployed state.

According to another particular feature, each of the bands is made of non-woven textile based on polyester fibres, needled and calendered, water being able to be filtered by the band.

According to another particular feature, each of the bands is made of non-woven thermobonded textile and having undergone thermofixing.

According to another particular feature, said first series and said second series of staples comprise each between three and eighteen staples spaced evenly and aligned in the same direction.

According to another particular feature, the bands are devoid of to coating or adhesion resin and each has a width determined at between 50 and 400 mm.

According to another particular feature, the cellular product comprises at least one support layer connected to the bands of the product and in contact with edges of the cells.

An additional aim of one or more embodiments of the invention is to propose applications of the cellular product.

For this purpose, use of the product according to one or more embodiments of the invention for the protection of terrain from erosion is proposed.

Use of the product according to one or more embodiments of the invention in conjunction with a support layer to serve as lost casing during casting of hardenable matter is also proposed.

An additional object of one or more embodiments of the invention is to propose a production method of a cellular product for rapidly making a cellular structure adapted to supporting applications.

For this purpose, one or more embodiments of the invention relates to a production method of a cellular product, comprising an assembly step of bands of the same width to form in a deployed form a cellular structure in honeycomb form, bands previously being superposed, characterised in that it comprises a step of joining together superposed bands by staples, in which two adjacent bands are attached to one another by a plurality of first series and second series of staples, each of the cells of the product being formed by two opposite portions belonging to two adjacent bands, these two portions being connected together at the edges of the cell, by a first series and a second series of staples aligned according to the band width, the alignment of staples of each of the series being done across the band width by a stapler fitted with an anvil holder offset laterally, after positioning of the anvil of the stapler under two adjacent bands.

The distance between a first series and second series of staples forming the edges of a cell correspond for example to a constant. This longitudinal distance diminishes naturally in moving from the stacked configuration to the deployed configuration. In a cell of hexagonal type formed by a pair of bands, this distance remains greater, even in the deployed configuration, than the distance between the two successive rows of staples acting to attach a wall of this cell against an adjacent band belonging to a different pair of bands.

The result is a method for cells making by stapling for a relatively large band width (typically of the order of 100 mm). For each connection between bands, the staples used are advantageously aligned according to the band width to allow complete opening of the cells. Each joining operation can be done rapidly (for example with 6 staples successively delivered to form a straight cell edge), in contrast to sewing operations, for example.

According to another particular feature, a first set and a second set of guide means in translation along the band width are utilised alternately, one band out of two, for positioning the stapler at levels in stapling alignment which are offset one band out of two, so as to enable making the cells.

According to another particular feature, an additional band is added, after a stapling cycle, to a superposition of already stapled bands together to commence an additional stapling cycle.

According to another particular feature, the anvil support is successively inserted in each of the cells made during the preceding stapling cycle to enable fixing of the staples during the current stapling cycle, the rest of the stapler being kept above the band last added for this current cycle.

An additional object of one or more embodiments of the invention is to propose manufacturing equipment of a cellular product so that a cellular structure adapted to supporting applications can be designed simply and rapidly.

For this purpose, one or more embodiments of the invention relate to manufacturing equipment of a cellular product, comprising an elongated support of superposed bands and a device for joining the bands together so that, in a deployed form, they form a cellular structure in honeycomb form, characterised in that the device is a stapler fitted with an anvil elongated holder and offset laterally for inserting the anvil of the stapler under two adjacent bands, to the side and according to the direction of the width of the bands, the stapler comprising a mobile knife (in translation) enabling, in association with the anvil, fixing the staples each oriented according to an orientation orthogonal to the general orientation of the anvil support, the equipment further comprising indication means of a first group and a second group of preferred positions for stapling, the first group and the second group being used alternately for one band out of two, for making the cells.

Therefore, the bands can be assembled to form the cellular structure without an adhesion operation harmful to conserving the rigidity of the product, nor a complex sewing operation. The specific arrangement of the stapler produces alignments of staples according to the band width which form the edges of the cells.

According to another particular feature, the stapler is made solid with a mobile system according to three directions whereof two orthogonal directions are together and parallel to a plane defined by the band support and a third direction is orthogonal to this plane.

Therefore, the longitudinal movement of the stapler to adequate stapling levels as well as lateral movement to be made for placing the same series of staples can be made by means of a mobile system (for example motorised and sliding on rails of a frame).

According to another particular feature, the support (S) of bands (B) is coupled to a plurality of guide means (6) of the stapler (1) distributed along the band support (B) as a function of preferred positions for stapling, the guide means (6) receiving a rod (tg) solid with the stapler (1) and parallel to the anvil support (10) for guiding the stapler (1) and fixing several staples (1) aligned together for a determined position.

According to another particular feature, the anvil support is connected to one end of an intermediate elongated element, this elongated element being kept away from the rest of the stapler by a lateral support arm attached to the other end of this elongated element.

Therefore, a pair of bands to be attached together (situated above the set of bands) can be raised above the anvil support, while remaining in line.

In fact, the stapler will not hinder keeping the bands in line since the longitudinal elongated element is arranged to the side of the stack of bands and sufficient space is left behind the anvil support (for example around 80 mm gap).

### BRIEF DESCRIPTION OF THE DRAWINGS

Other particular features and advantages of the present invention will emerge more clearly from the following description, given in reference to the attached diagrams, in which:

FIG. 1 illustrates a perspective view of manufacturing equipment of the cellular product according to an embodiment of the invention;

FIG. 2 illustrates a view in longitudinal section illustrating the assembly of bands by means of the stapler of the equipment according to the invention;

FIG. 3 schematically illustrates in perspective the structure of a cellular product in keeping with the invention prior to placing and filling the cells;

FIG. 4 schematically illustrates in perspective a cellular structure whereof one of the faces is linked to a reinforcement, as described in the prior art by document WO 95/38417, and in which the connection between the bands is made by sewing or adhesion.

FIG. 5 illustrates a plan view of a cell of a product according to the invention;

FIG. 6 illustrates a view in longitudinal section of a stapler in line whereof the anvil support (10) is offset relative to the rest of the stapler.

### DETAILED DESCRIPTION

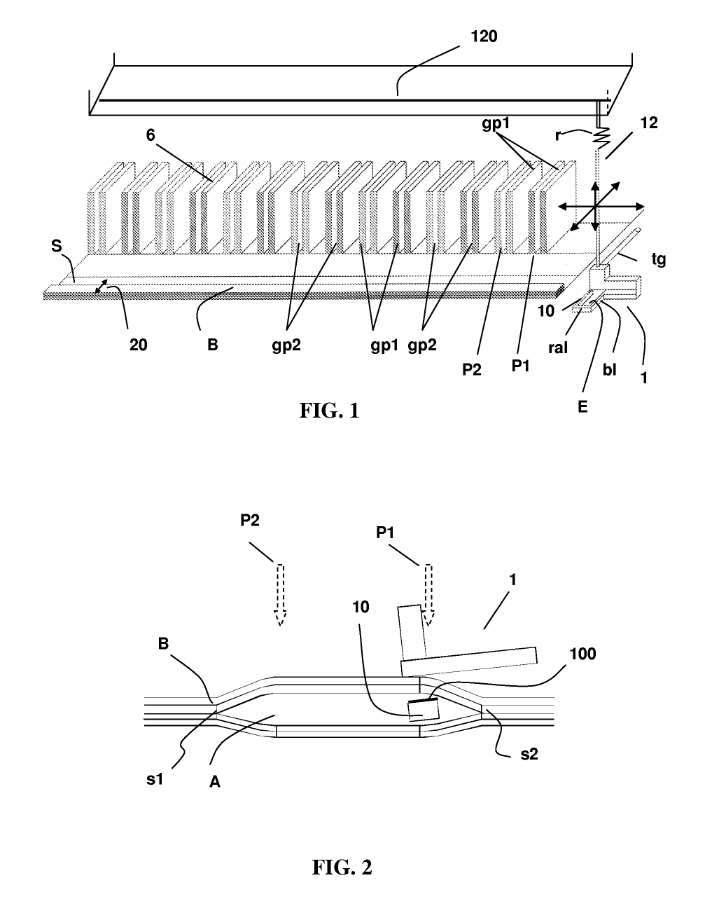

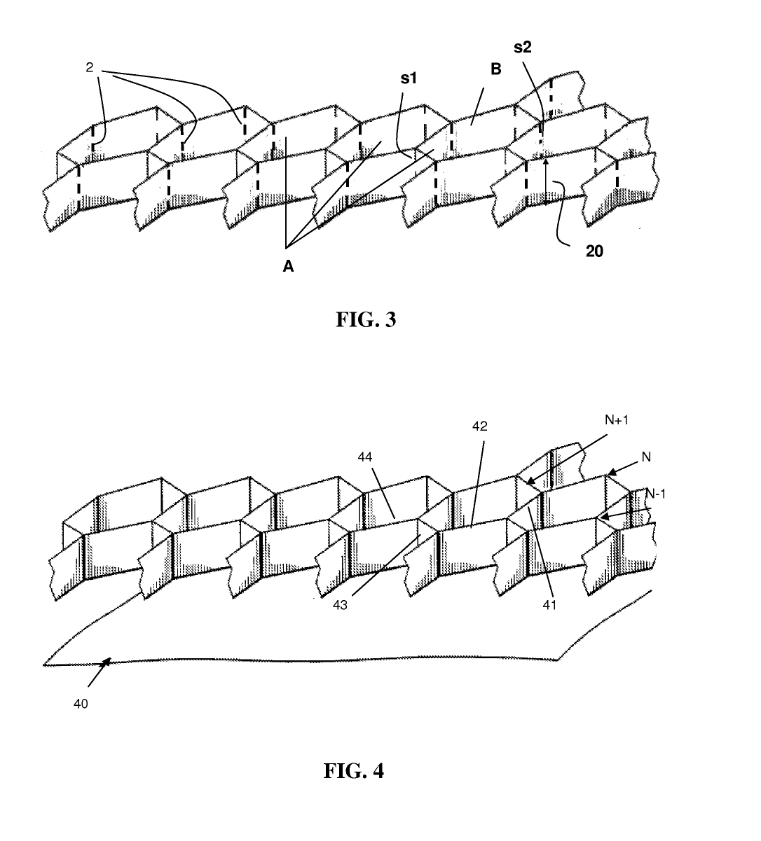

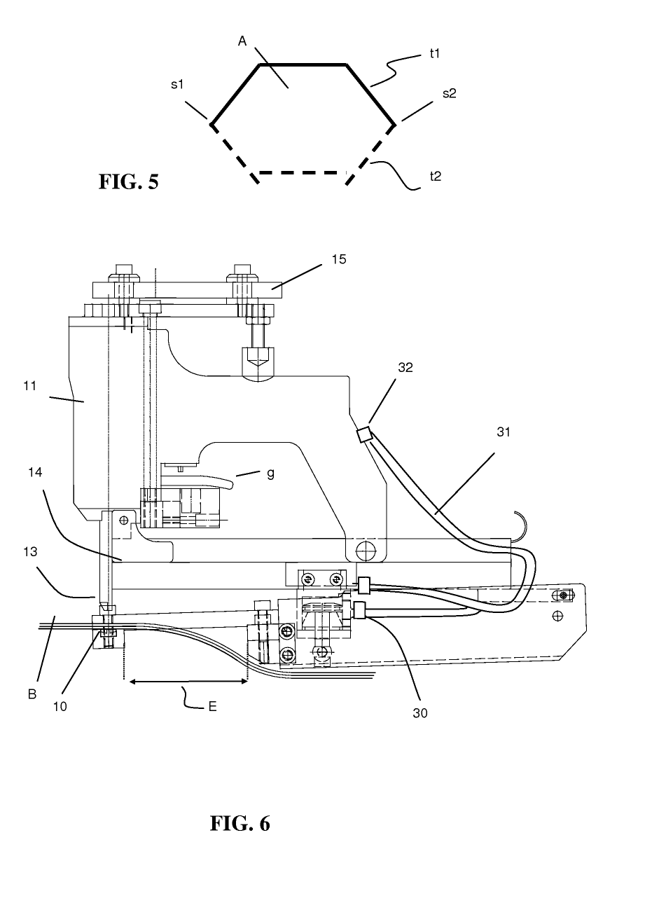

In reference to FIGS. 1, 3 and 5, the cellular product according to an embodiment of the invention is elaborated by joining several bands (B) to form in a deployed configuration a cellular structure in honeycomb form. Two bands (B) are superposed on a support (S) prior to making the fixings. As in the structure of FIG. 4, the resulting cellular product comprises bands (B) having the same general orientation and each breaking down into elementary patterns. FIG. 3 also discloses an elementary band pattern (B) comprising a portion paired to an adjacent band, an intermediate portion without contact with other bands, a portion attached to the other adjacent band and again an intermediate portion. This pattern is repeated several times for one band (B). Each of the cells (A) of the product is formed by two opposite sections (t1, t2) belonging to two adjacent bands. As illustrated in FIG. 5, such a section (t1) comprises a portion attached to another band and two intermediate portions. From the difference of the structure of FIG. 4, adhesion or sewings between the band portions in contact are not necessary.

The bands (B) are advantageously attached to one another by staples (2) fixed in the direction of the band width (20). In the embodiment of FIGS. 3 and 5, the two opposite sections (t1, t2) can be interconnected and form one cell (A) due to the presence of a first series (s1) and a second series (s2) of staples (2) aligned according to the band width (20). These two series (s1, s2) therefore correspond to two edges of the cell (A) in the form of a hexagon. These two edges can be considered, in a non-limiting manner, as opposite one another relative to the same cell. Other similar forms of cells which the specialist can appreciate naturally can be made also.

The bands (B) are selected for example in a material of non-woven textile type, for example based on fibres of polymer and needled. To improve rigidity and shelf life of the cellular product over time, the material making up the bands (B) can be thermobonded and thermofixed. Thermobonding helps bind the fibres together, for example by introducing additional binding fibres (thermal consolidation within the product due to incorporation of fired fibres), for example polypropylene fibres. Thermofixing can consist of firing the material to thermally consolidate the surface. Such thermal processing improves resistance of the material and prevents excessive elongation to wear. The material of the band (B) remains sufficiently porous and permeable for filtering water. This permeability enables to reduce the forces undergone by the product in use. Filling (earth, . . . ) preserves then its cohesion.

A non-limiting example of non-woven needled material is DUTEXIM 41-45C THU sold by Tharreau Industries, and is based on polyester fibres. The type of material selected can have undergone calendering and thermofixing, so as to offer excellent dimensional stability at high temperature, as well as very good evenness in weight and thickness (constant thickness is for example typically of the order of 2 or 3 mm). The calendering especially reduces the thickness.

The bands (B) are devoid of coating or adhesion resin and can each be the same width (20) determined as between 50 and 400 mm. It is understood that the cellular product in its deployed configuration will be a height which corresponds to the width (20) of the bands (B). By way of example, the first series (s1) and the second series (s2) of staples can each comprise between three and eighteen staples (2) spaced evenly. These staples (2) are rigorously aligned, as illustrated in FIG. 3. For an edge formed by U-shaped staples each comprising a central rod prolonged at its two ends by a U-shaped foot, the feet being designed to be bent back, the central rods of these staples are aligned. The staples (2) are for example made of stainless steel.

The method and the manufacturing equipment of the cellular product will now be described in conjunction with FIGS. 1, 2, and 6.

In the example of FIG. 1, the manufacturing equipment comprises an elongated support (S) for receiving the superposed bands (B) and a stapling device for joining the bands (B) together. The bands (B) are stacked and can form a compact set. The stapling device will be positioned along this stack, for example mobile longitudinally. In at least one embodiment of the invention, a guide rail (120) is provided in an elevated frame relative to the table or support (S) where the bands (B) are placed. For each stapling operation of a series (s1, s2) of staples, a guide is provided for limiting the longitudinal movement of the stapling device.

This device comprises a stapler (1) in line supported by the frame and made mobile, due to a mobile system mounted on the frame, according to three directions whereof two orthogonal directions are together and parallel to the plane defined by the band support (B) and a third direction orthogonal to the plane defined by the band support (B). The stapler (1) must in fact be able to move laterally on a constant longitudinal level to cause perfect alignment of staples (2) of the same series (s1, s2). The stapler (1) used differs from a conventional stapler in order to overcome the difficulty of executing this type of stapling on a band width (20) able to accept alignment of several staples (2).

This difficulty is overcome by providing a stapler (1) fitted with an anvil support (10) offset laterally for inserting just the anvil (100) of the stapler (1) under two adjacent bands to be connected together. In the example of FIGS. 1 and 6, the stapler (1) comprises on a U-shaped side formed by three elements:
the anvil support (10),
an elongated intermediate element (ral) whereof one end is connected to said support (10),
a lateral support arm (bl) attached at the other end of the elongated element (ral), this lateral arm (bl) making the join with the rest of the stapler (1).

The elongated element (ral) is sufficiently offset to raise a pair of bands and introduce them longitudinally, over the entire band width (20), between the anvil support (10) and the exit (13) of staples (2) of the main body (11) of the stapler (1). The elongated element (ral) remains for example continually in a side position relative to the superposed bands (B) during the process. Lateral movement of the stapler (1) is limited for example so that lateral shift is maintained between the bands (B) and the elongated element (ral).

To complete initial stapling cycle relative to the join between two bands, the anvil support (10) is inserted under the pair of bands (B), as illustrated in FIG. 6. The total number of longitudinal stapling positions is for example a determined number of pairs. It is understood for making the cellular structure that a stapling cycle must be limited to placing staples for just half of these positions, the following cycle being dedicated to the remaining positions. All the stapling positions are therefore made during two passages/cycles of the stapler (1), a band (B) having been added on the top between the two cycles.

The equipment comprises for example indication means of a first group and a second group of preferred positions (gp1, gp2) for the stapling, the first group and the second group (gp1, gp2) being used alternately for one band out of two, so as to make the cells (A). Therefore, the first cycle provides stapling for the first group of positions (gp1) and the second cycle provides stapling for the second group of positions (gp2).

As illustrated in FIG. 2, for all the cycles following the first cycle, the anvil support (10) must be successively inserted in each of the cells (A) made during the preceding stapling cycle for fixing the staples (2) of the current cycle. Naturally, the rest of the stapler (1) is kept above the added band (B) for each of the new cycles. Once the support (10) is inserted in a cell (A) resulting from the preceding cycle, two consecutive alignments of staples will be made. Next, the anvil support (10) moves completely to the side via appropriate translation movement of the stapler and could be inserted in another cell (A) resulting from the preceding cycle (the two upper bands being raised).

In the example of FIGS. 1 and 2, consecutive alignments can each be made precisely by means of guiding the lateral movement of the stapler (1). Keeping it in the respective positions (P1, P2) corresponding to the direction of alignment can be done by means of a rod (tg) solid with the stapler (1) and intended to cooperate with guide means (6). In reference to FIG. 1, the support (S) of bands (B) is for example coupled to a plurality of guide means (6) of the stapler (1) distributed along the band support (B) as a function of the preferred positions for stapling. These guide means (6) receive the rod (tg), by engagement between two walls for example, and block longitudinal movement of the stapler (1). Pairs of plates each form for example a guide for a determined position, the plates being for example made in a non-limiting manner from wood, metal, plastic or thermoplastic, such as for example methyl polymethacrylate, also designated as PMMA. The rod (tg) which is parallel to the anvil support (10) thus guides stapling the staples (2) of the same series according to width (20). This assuredly results in fixing of several staples (1) aligned together for a determined position (P1, P2).

The stapler (1) comprises a mobile knife in translation (not shown) enabling in association with the anvil (100) the staples (2) to be fixed. The position of the knife and the orientation of the loader (14) of staples are adapted so that the staples (2) are each oriented according to an orientation orthogonal to the general orientation of the anvil support (10). The descending movement of the knife allows insertion of the staple (2) in the two bands to be fixed, whereas the anvil (100) stresses the staple ends and folds them back onto the lower band of the bands to be fixed.

It is understood that the stapler (1) will staple in line the bands (B) two by two without requiring the slightest lateral movement for the bands (B), the stack always staying straight. The spacing (E) between the main body (11) of the stapler (1) and the transversal anvil support (10) does not in fact modify the general orientation in length of the two upper bands (B). Offset according to the length between two successive bands is, for example, avoided. It is only the stapler (1) which moves laterally once it arrives in a stapling position (P1, P2). In the example of FIG. 1, the connection (12) of the stapler (1) to the elevated frame can be equipped with a spring (r) or similar elastic return means facilitating the raising operations of the stapler (1) required for gripping the bands (B) to be stapled. Raising the bands (B) for insertion of the anvil support (10) can be manual or can done by a complementary raising tool of a blade which can be introduced under the two upper bands (B) of the stack. A plate (15) can be fixed on the main body (11), for example on the top, and enable attachment by an arm or descending handling rod connected to the mobile system of the elevated frame. Naturally, another arrangement can cause shifting of the stapler (1). The latter can alternatively be supported laterally for example and the elevated frame can be replaced by a rail on the ground supporting the mobile system attached laterally to the stapler (1).

In reference to FIG. 6, the stapler (1) can be of the actuator piston type, actuated manually via a trigger (g) and/or pneumatically. An automaton can trigger stapling synchronised with the movements of the system shifting the stapler (1). This automaton can utilise a program for controlling the stapler, taking into consideration the shifts of the mobile system mounted on the frame (not shown) and signals indicating stapling positions. Alternatively, the pneumatic connection (31) and associated attachments (30, 32) can be left out and the stapling operation can be done manually, by means of the indication means of the respective groups of preferred positions (gp1, gp2).

The production method comprises several pairs of cycles carried out as follows:
addition of a band on a stack (or starting a stack) of bands (B) to start the cycle;
placing staples (2) on the two upper bands of the stack, for a first group of stapling positions (gp1);
adding an additional band on the stack of bands (B) to start the following cycle;
placing staples (2) on the two upper bands of the stack, for a second group of stapling positions (gp2) (positions offset relative to those of the first group (gp1)).

As illustrated in FIG. 1, producing the positions (gp1, gp2) for one or the other type of cycle is permitted by a first set and a second set of guide means (6). A pair of guide means is provided to produce stapling positions (P1, P2) of a cycle represented in FIG. 2, while a following pair of guide means is provided to produce stapling positions of another cycle. During a determined cycle, the stapler (1) will therefore stop at the level of two successive devices of guide means (6) then go on without stopping the two devices according to the guide means. These two latter in fact serve only the following cycle. There are therefore alternating of pairs of guide devices respectively useable for one or the other of the cycles. In other words, this first set and this second set of guide devices (6) are used alternately one band out of two for positioning the stapler (1) at stapling alignment levels which are offset for one band out of two, so as to enable making the cells (A).

One of the advantages of the product is that fixing between the bands is simpler than with sewing operations and preserves very good shelf life over time, the rigidity of the structure being durably preserved (compared to products coated with adhesive/resin). The product is, for example, in the form of a roller prior to being deployed, which especially facilitates its storage and transport.

It must be evident, for the person skilled in the art, that the present invention allows embodiments in numerous other specific forms without departing from the field of application of the invention as claimed.

1. A cellular product comprising a plurality of bands joined together to form in a deployed form a cellular structure in honeycomb form, the product having a height which corresponds to the width of the bands for said deployed form, said bands being connected to one another by staples, each of the cells of the product being formed by two portions belonging to two adjacent bands, the two portions being connected together by a first series and a second series of staples aligned according to the band width, the two series corresponding to two edges of the cell.

2. The cellular product as claimed in claim 1, in which each of the bands is made of non-woven textile based on polyester fibres, needled and calendered, water being able to be filtered by the band.

3. The cellular product as claimed in claim 1, in which each of the bands is made of thermobonded non-woven textile and having undergone thermofixing.

4. The cellular product as claimed in claim 1, in which said first series and said second series of staples each comprise between three and eighteen staples spaced evenly and aligned in the same direction.

5. The cellular product as claimed in claim 1, in which the bands are devoid of coating or adhesion resin and each has a determined width of between 50 and 400 mm.

6. The cellular product as claimed in claim 1, comprising at least one support layer connected to the bands of the product and in contact with edges of the cells.

7. A method of using the product as claimed in claim 1 for protection of terrain from erosion.

8. A method of using the product as claimed in claim 1 in conjunction with a support layer to serve as lost casing during casting of hardenable matter.

9. A production method of a cellular product, comprising an assembly step of bands of the same width for forming in a deployed form a cellular structure in honeycomb form, bands being previously superposed, the method comprising a step of joining together bands superposed by staples, in which two adjacent bands are attached to one another by a plurality of first series and second series of staples, each of the cells of the product being formed by two opposite portions belonging to two adjacent bands, these two portions being connected together at the edges of the cell, by a first series and a second series of staples aligned according to the band width, the alignment of staples of each of the series being made according to the band width by a stapler fitted with an anvil support offset laterally, after positioning of the anvil of the stapler under two adjacent bands.

10. The method as claimed in claim 9, in which a first set and a second set of guide means in translation according to the band width are utilised alternately one band out of two for positioning the stapler at levels in stapling alignment which are offset for one band in two, for making the cells.

11. The method as claimed in claim 9, in which an additional band is added, after a stapling cycle, on a superposition of bands already stapled together to commence an additional stapling cycle.

12. The method as claimed in claim 11, in which the anvil support is successively inserted in each of the cells made during the preceding stapling cycle for fixing the staples during the current stapling cycle, the rest of the stapler being kept above the band last added for this current cycle.

13. Equipment for making a cellular product, comprising an elongated support of bands superposed and a device for joining the bands together so that in a deployed form the bands form a cellular structure in honeycomb form, the device comprising a stapler fitted with an anvil support elongated and offset laterally for inserting the anvil of the stapler under two adjacent bands, to the side and according to the direction of the width of the bands, the stapler comprising a mobile knife combining with the anvil to fix staples each oriented according to an orientation orthogonal to the general orientation of the anvil support, the equipment further comprising indication means of a first group and a second group of preferred positions for stapling, the first group and the second group being used alternately for one band out of two, so as to enable making the cells.

14. Equipment as claimed in claim 13, in which the stapler is made solid with a mobile system in three directions whereof two orthogonal directions are joined together and parallel to a plane defined by the band support and another direction orthogonal to this plane.

15. Equipment as claimed in claim 13, in which the support of bands is coupled to a plurality of guide means of the stapler which are distributed along the band support as a function of preferred positions for stapling, the guide means receiving a rod solid with the stapler and parallel to the anvil support to guide the stapler and enable fixing of several staples aligned together for a determined position.

16. Equipment as claimed in claim 13, in which the anvil support is connected to one end of an intermediate elongated element, this elongated element being kept away from the rest of the stapler by a lateral support arm attached to the other end of this elongated element.
